(19) United States
(12) Patent Application Publication
(10) Pub. No.: US 2015/0292238 A1
(43) Pub. Date: Oct. 15, 2015

(54) LOCK DEVICE BASED ON A MECHANICALLY RE-PROGRAMMABLE DISC-TYPE DEVICE AND KEY FOR THE SAME

(71) Applicant: VIRO S.p.A., Zola Predosa (Bologna) (IT)

(72) Inventor: Filippo BASTIANINI, Bologna (IT)

(21) Appl. No.: 14/443,295

(22) PCT Filed: Dec. 5, 2013
(86) PCT No.: PCT/IT2013/000338

§ 371 Date: May 15, 2015

(30) Foreign Application Priority Data
Dec. 10, 2012 (IT) BO2012A000662

(51) Int. Cl. E05B 27/00

(52) U.S. Cl. CPC E05B 27/005; E05B 27/0014; E05B 27/0007

(57) ABSTRACT

A cylinder and key lock mechanism is unlocked when a specific combination of rotation angles of dialer groups, each constituted by one internal dialer disc and by one external dialer ring coupled through teeth, is dialed through rotation of the key having a formed cipher. A security mechanism, being part of the key and driven by the insertion of the key into the cylinder, enables re-programming. When unlocked and with re-programming enabled, re-programming is possible where the inner dialer discs are decoupled from the respective outer dialer rings, the key can be rotated driving only the inner dialer discs and extracted leaving the system in a re-programming configuration. A new key having a different cipher can be inserted and the system exited re-programming with a different coupling between the inner dialer discs and the respective outer dialer rings so that they couple with the new key cipher.

### TECHNICAL FIELD OF THE INVENTION

The present invention concerns a cylinder type lock having a mechanically re-programmable rotating rotating disc type mechanism and a key for the same.

### BACKGROUND ART

It is known an number of re-programmable cylinder type lock devices based on a piston/counter-piston mechanism that can be reprogrammed through a mechanism able to change the equivalent length of the elements that act as pistons so that to learn the cipher of a new key inserted into the cylinder when this is in a condition where all the elements acting as piston have been preventively decoupled the one with respect to the other by means of a suitable procedure.

As an example are here listed the patents and patents applications U.S. Pat. No. 6,119,495A, U.S. Pat. No. 7,340,929B1, US2003041630A1, WO9840589A1, WO2011091832A1, WO2011098109A1, WO2011134610A1, TW200951282A, TW201009175A, TW201009176A, US2006112748A1, WO2004079134A1, WO2004079135A1, EP0210037A3, TW200944643A, TW200946757A, TW201028520A, TW201028522A, TW201118227A, TW201135039A, TW1361244B, U.S. Pat. No. 7,937,976B2, U.S. Pat. No. 8,074,480B2, US2003159483A1, US2005172687A1, US2009277234A1, US2009277240A1 US2010018267A1, US2010050717A1, US2010101288A1, US2011041577A1, WO2006055281A2, WO2009008852A8, WO2012135398A1, and in particular are to be considered of special relevance some solutions in which the elements that acts as pistons can be decoupled the one with respect to the other by means of a respective translation along the axis of the cylinder, as in the patents and patent applications US2008307841A1 US2010101289A1, US2011154872,A1, WO2009151464A1, WO2011088861A1, WO2012021384A1.

All the known solutions of re-programmable cylinder lock are characterized by a number of limitations concerning:
low resistance against the picking techniques according to the “bumping” method that are applicable to the systems in which the mechanism comprises a contrast spring such as in the known piston/counter-piston mechanisms;
low level of security against unauthorized re-programming, since the re-programming procedure is easily accessible or, even in case it requires a special key, such a key can be easily obtained starting from one of the conventional access keys modifying it in an easy way;
low level of security against the unauthorized duplication of the keys, and in particular of that of the type capable to enable the re-programming procedure, since are characterized by keys that are constituted by simple elements not having moving mechanisms.

Are known many systems of cylinder-type lock comprising a disc-type mechanism in which the unlocking of the lock is obtained when a specific combination of the angle of rotation of the disc elements driven by the rotation of the key on the lateral surface of which is obtained a suitable cipher by means of millings such as for example in the patent application EP0622508A1. The said systems cannot be re-programmed without changing or modifying their own components and furthermore they have a low level of security against the unauthorized duplication of the keys since they couple with keys that are constituted by simple elements without moving mechanisms.

Are known many non-reprogrammable cylinder type locks that are characterize by a high level of security against the unauthorized duplication of the keys since the couple with keys that comprise moving mechanisms like those described in the patents or patent applications CA1153903A1, DE3542008A1, DE3709417A1, DE3711935A1, DE102004045792A1, EP0890694A1, EP1470307A1, EP1726749A2, ES294528U, ES2196492T3, U.S. Pat. No. 1,567,979A, U.S. Pat. No. 4,377,082A e WO03064795A1.

### DISCLOSURE OF THE INVENTION

In a first broad independent aspect, the present invention provides a lock device capable of being reprogrammed an infinite number of times with a mechanical procedure that does not require the substitution, addition or the elimination of components, and that could be obtained bringing the mechanical system in a re-programming status by the action of a key having the present unlocking cipher and a specific mechanism to activate the status, and successively by inserting one key having a new and different cipher and an analogous mechanism.

In a first subsidiary aspect, the present invention combines the re-programmable lock-key coupling with a lock/unlock mechanism that does not have neither contrasting springs nor gravity contrast with the scope of ensuring the intrinsic resistance to the picking techniques with the “bumping” method.

In a third subsidiary aspect, the present invention combines the lock mechanism with a key that comprises a complex mechanism with moving parts, at least for what concerns the control of the re-programming operation, so that to ensure an high level of security against the unauthorized re-programming and against the unauthorized duplication of the keys

### BRIEF DESCRIPTION OF DRAWINGS

A full and enabling disclosure of the present invention, including the best mode thereof, directed to one of ordinary skill in the art, is set forth in the specifications, which makes reference to the appended figures, in which:

FIG. 1 illustrates an exploded view of one preferred embodiment, even if not binding, of the lock of the present patent.

FIG. 2 illustrates some components of the lock of the same preferred embodiment of FIG. 1 shown from a different point of view with the scope of highlighting specific functional characteristics of the same.

FIG. 3 illustrates some sectional views of the preferred embodiment already depicted in FIG. 1, shown in the configurations in which: the locking mechanism is in the state of “closed”, the mechanism of reprogramming is in the inactive state, the mechanism of consent to the reprogramming is in the disabled state.

FIG. 4 illustrates some sectional views of the preferred embodiment already depicted in FIGS. 1 and 3, shown in the configuration in which: the locking mechanism is in the state of “open”, the mechanism of reprogramming is in the active state, the mechanism of consent to the reprogramming is in the enabled state.

### DETAILED DESCRIPTION OF THE PREFERRED EMBODIMENTS

Selected combinations of aspects of the disclosed technology correspond to a plurality of different embodiments of the present invention. It should be noted that each of the exemplary embodiments presented and discussed herein should not insinuate limitations of the present subject matter. Features or steps described as part of one embodiment may be used in combination with aspects of another embodiment to yield yet further embodiments. Additionally, certain features may be interchanged with similar devices of features not expressly mentioned which perform the same or similar function,

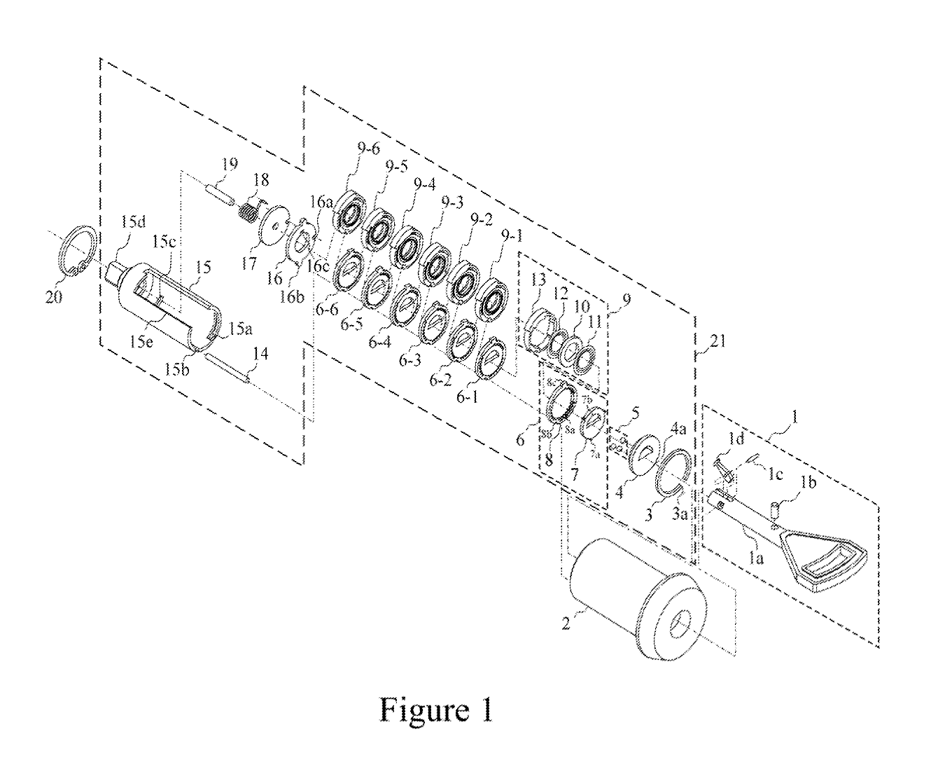

In FIG. 1 is presented a preferred embodiment of the device object of the present invention.

The device comprises at least one key (1) characterized by a body (1a) having a protruding member on the surface of which can be made a cipher, for example by means of removing material, and comprising at least one mechanism constituted by a moving element (1d), eventually connected to the same body (1) by means of at least one connecting member (1c), in which the said moving element (1d) can rotate and/or translate with respect to the body (1).

The system comprises at least one stator body (2) having at least one cavity suitable to accept other internal components (from 3 to 19) of the lock among which at least one rotor body (15) capable to drive, even if not directly, with a suitable part of mechanical coupling (15d) at least one element, in example one bolt, not necessarily being part of the same lock; the said rotor body (15) being at least partially axially retained inside the stator by at least one fixing element (20).

The lock comprises furthermore comprises at least one locking mechanism comprising a plurality of “dialer disc” groups (6 and from 6-1 to 6-6) each of which constituted by at least one inner dialer disc (7) having at least one tooth (7a) and one opening (7b) suitable to couple with the prolonged protrusion of the body (1a) of the key (1), and at least one outer dialer ring (8) characterized by at least one indentation (8b) on the outer border and by a multiplicity of indentations (8a) each suitable have a coupling with the tooth (7a) of the inner disc (7) with a different angle of rotation between the same and in a way that the disc (7) could drive jointly the axial rotation of the ring (8) under the action of the key (1) when the said coupling (7a-8a) is active, and the said outer dialer ring (8) eventually comprising also at least one tooth (8c) suitable to limit the possibility of rotation with respect to the rotor body (15) within limits imposed by the coupling between the tooth (8c) and a seat (15) obtained in the rotor body (15).

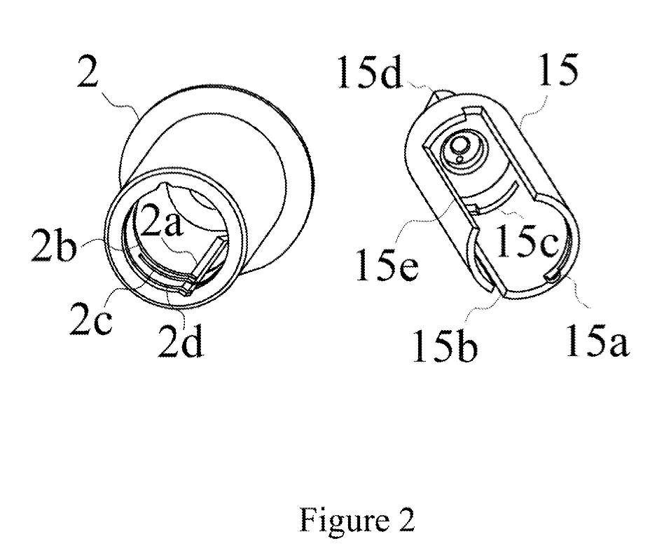

The locking mechanism comprises moreover a least one engagement element (14) partially housed in a seat (15b) obtained in the rotor body (15), that, in the status of “closed lock”, is forced to stay partially also into a seat (FIG. 2, 2a) obtained in the body of the stator (2) so that to forbid the rotation of the rotor (15) with respect to the same stator (2); and the said engagement element (14) in the status of “open lock” can leave the seat (2a) being included in the outline of the rotor (15) and disengaging in this way its possibility of rotation with respect to the stator (2) when all the “dialer disc” groups (6 and from 6-1 to 6-6), under the drive of a partial rotation of the key (1) inserted inside the lock, are rotated in a way that aligns the indentations (8b) with seat (15b) and deliver in this way a slot sufficient for the complete inclusion of the engagement element (14) within the outline of the rotor group (21).

The lock comprises moreover at least one re-programming mechanism controlled by a specific action of the key (1) and suitable to consent that in each “dialer disc” group (6 and from 6-1 to 6-6) the inner dialer disc (7) could be decoupled from its respective outer dialer ring (8) and successively the key (1) could be extracted and substituted with one analogue having different cipher and, by mean of the action of this latter, each inner dialer disc (7) could be again coupled to its respective outer dialer ring (8) in a configuration between the tooth (7a) and one of the indentations (8a) characterized by an angle of rotation of the disc 87) and the ring (8) that fits the cipher that characterizes the new key.

In the preferred embodiment depicted, not binding, the said re-programming mechanism comprises a multiplicity of “spacer disc” groups (9 and from 9-1 to 9-6) each of them adjacent to one of the “dialer disc” groups and each of them comprising at least one outer spacer ring (13) and one or more inner spacer discs (10, 11 and 12) suitably shaped and arranged in a way to allow that an axial translation of the pile of inner dialer discs (7) alternated to inner spacer discs (10, 11 and 12) moves each inner dialer disc (7) inside one adjacent outer spacer ring (13) in this way decoupling the same from the respective outer dialer ring (8). In the preferred embodiment depicted, not binding, the said translation is controlled by the axial thrust of the key (1) that, by means of a protrusion such as in example that of the pin (1b), leans to a front disc (4) shaped so that to push on the pile of the inner dialer and spacer discs (7, 10, 11e 12), with the contrast of the axial thrust of a spring (18) acting on the opposite side of the pile through the shutter disc (17), contrast that is potentially capable to push the opposite control stroke, and in the embodiment depicted the position of decoupling between the dialer discs (7) and the rings (8) reached with the said axial translation can be held when the rotor is driven in partial reverse rotation of the key (1), thanks to at least one tooth (4a) of the front disc (4) that, in the position in which the axial translation is allowed, enters and engages one track (15a) obtained in the rotor body (15) and shaped in a suitable way, so that the key (1), at the end of the partial reverse rotation, could be extracted leaving the system in the status of decoupling between the discs (7) and rings (8) and could be inserted a new key (1) characterized by a different cipher.

In the preferred embodiment depicted, not binding, the front disc (4) has furthermore at least one cavity suitable to house at least one element (5) made of a high hardness material with the aim of improve its resistance against drilling; and it is furthermore present one partial spacer ring (3) having one opening or indentation (3a) suitable to accept the tooth (4a) of the front disc (4) when it is not engaged in the track (15a), the said spacer ring (3) having the function of keeping the alignment between the front disc (4) and the rotor and of allowing in the staid status the free rotation, again with the aim of improve the resistance against drilling of the lock.

In the preferred embodiment depicted, non-binding, the group “spacer disc” is comprising more inner spacer discs, and in particular one main inner spacer disc (10) preceded and followed by auxiliary inner spacer discs (11 and 12) shaped in a way that do not have points of contacts on the external periphery with all the other discs between the said auxiliary discs (11 and 12) are placed, with the scope of avoiding, in the condition of decoupling between the inner dialer discs (7) and the respective outer dialer discs (8), the possibility of interference between the edges of the teeth (7a) and those of the indentations (8a); and the said auxiliary inner spacer discs (11 and 12) space the adjacent discs in a way that makes possible, in the axial translation that brings to the decoupled configuration, it is reached a state in which the inner dialer discs (7) replace the main inner spacer discs (10) inside the spacer rings (13) while the positions formerly occupied by the same inner dialer discs (7) could be occupied by main inner spacer discs (10) or, only for the first “dialer disc” group , by a portion of the front disc (4).

The lock furthermore comprises at least one security mechanism for the consent of the reprogramming controlled by means of the moving mechanism forming part of the key (1) and designed to allow that the mechanism of reprogramming can be successfully activated only in a mechanical state in which they are simultaneously realized the condition of “open” of the locking mechanism and the enable condition of the consent to the reprogramming of the mechanism of consent to the same reprogramming.

In the preferred embodiment depicted, not binding, the consent to the reprogramming mechanism comprises at least one disk of enabling of the consent to the reprogramming (16) shaped so as to offer no possibility of coupling with the body profile of the key (1a), but rather equipped with at least one tooth (16b) on the peripheral edge and with at least one indentation (16c) suitable to engage with the movable element (1d) forming part of the moving mechanism of the key (1) when said moving element (1d) is pushed to protrude outside the outline of the key body (1a) by the presence of a protrusion, such as the head of the pin (19), which, in the insertion stroke of the key (1), goes to engage the seat formed in the body of the key (1a) that was previously occupied by the mobile element (1d) that was there in order not to interfere with the profile of the openings (7d) of the inner dial discs (7) intended for the insertion of the key (1) itself, and wherein the said disk enabling the consent to reprogramming (16) is driven in a rotation, eventually contrasted by a spring (18), by the moving element (1d) during the rotation of the key (1) intended to bring the “dial disc” groups (6 and from 6-1 to 6-6) in the “open” configuration of the locking mechanism and by means of the said rotation reaches a specific position in which the teeth (16b) on the peripheral edge of the disc (16), which engage each in a suitably shaped opening (15c) on the wall of the rotor body (15), no longer find impediment to a possible axial translation of the disk (16) by the shape of the opening (15c).

In the preferred embodiment depicted, not binding, the achievement of the said position by the teeth (16b) with respect to the opening (15c) is a necessary but not sufficient condition to ensure that the said translation is actually possible because the same teeth (16b), the projection of which is such as to exceed the outline of the rotor body (15), are engaged inside a front circular track (FIG. 2, 2b) obtained on the surface of the cavity of the stator (2), track that the teeth (16b) may leave to move into a different rear track (FIG. 2, 2c) obtained on the same surface at a different axial position when they are aligned with a longitudinal groove that connects the two tracks and that is displaced at an angle that can be reached by the teeth (16b) only with a rotation of the rotor assembly that is only possible when the locking mechanism is in the state of “open”.

in the preferred embodiment depicted, non-binding, at least one of the longitudinal grooves which connect the different tracks (FIG. 2, 2b and 2c) coincides with the seat (FIG. 2, 2a) on the stator for the engagement element (14), and also the rear track (FIG. 2, 2c) extends for a limited angle so that to consent the reverse rotation of the key (1) suitable to bring the same in the position of extraction but leaving the lock in a stable configuration of reprogramming until the insertion of a new key (1) that can drive the exit out from that state.

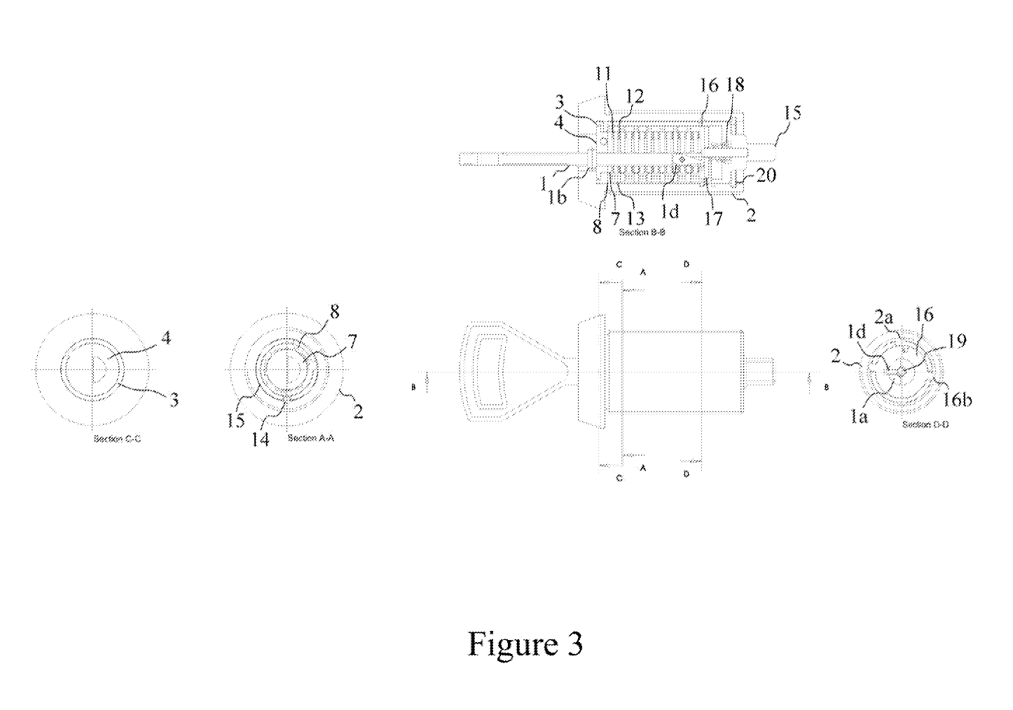

In FIG. 3 are shown some sectional views of the preferred embodiment already depicted in FIG. 1, shown in the configuration in which:
The locking mechanism is in the state of “closed”, in which it is prevented that the relative rotation between the stator (2) and the rotor assembly due to the position assumed by the engagement element (14);
The mechanism of reprogramming is in the inactive state, in which the inner dial discs (7) are coupled to the respective combiners external rings (8), and
The mechanism of consent to the reprogramming is in the disabled state, in which the teeth (16b) of the disc (16) are not aligned with the grooves (2a).

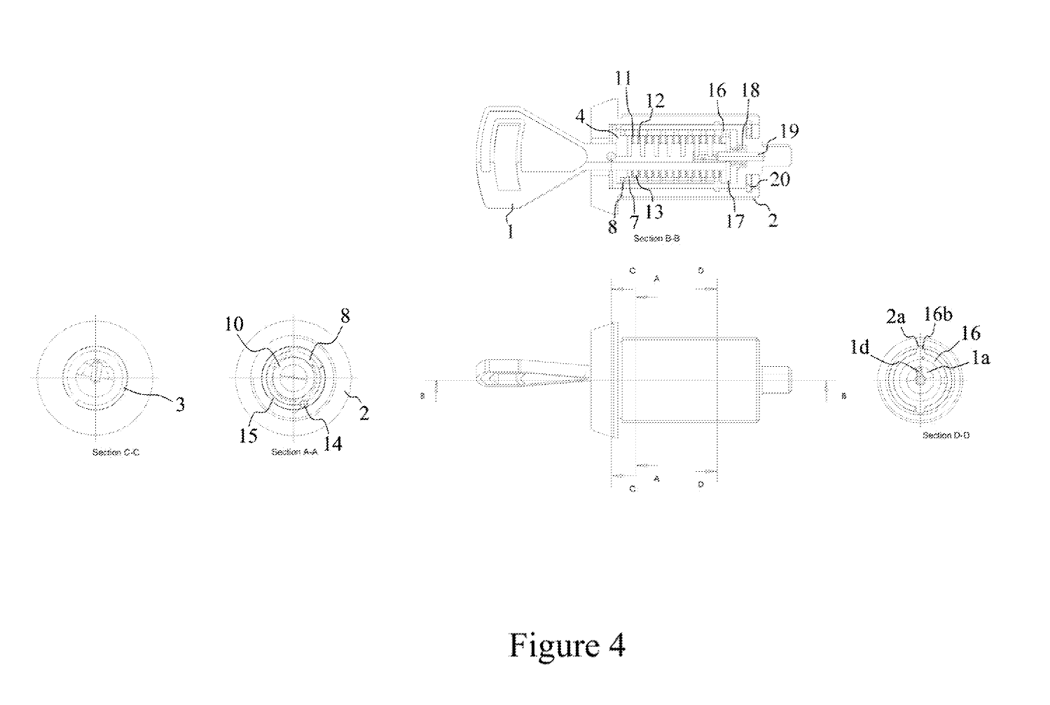

In FIG. 4 are shown some sectional views of the preferred embodiment already depicted in FIGS. 1 and 3, shown in the configuration in which:
The locking mechanism is in the state of “open”, in which the engagement element (14) is displaced within the outline of the rotor assembly,
The mechanism of reprogramming is in the active state, in which the inner dial discs (7) are disengaged from the outer dial rings (8) and displaced in correspondence of the spacer rings (13), and
The mechanism of consent to the reprogramming is in the enabled state, in which the teeth (16b) of the disc (16) are aligned with the grooves (2a),

In a second possible preferred embodiment (not shown), non-binding and partly referable to the one already described, are absent elements, such as the tooth (8c) of the rings (8), intended to limit the angle of rotation of the outer dial rings (8) with respect to the rotor body (15) and, in the condition of locking mechanism open, the dragging of the rotor assembly by the key (1) is obtained through the disk of enabling of the consent to the reprogramming (16).

In a further possible preferred embodiment (not shown) , non-binding and partly referable to that described above, the dragging of the rotor assembly by the key (1) is obtained through a further dragging disc (not shown), similar to disk of enabling of the consent to the reprogramming (16), but characterized by teeth (16b) suitable to act on the rotor body (15) without however exceed the outline of the latter and therefore not capable to engage the stator (2), and possibly the keys (1) can be characterized by the kinds of mechanisms with moving element (1d) different for engaging respectively whether only the driving disk, in case you want that the key could be used to open the lock but can not be used for control its mechanism of reprogramming, or to engage instead, or possibly in addition, the disk of enabling of the consent to the reprogramming (16), in case you want that the key could be used both to open the lock and to control the mechanism of reprogramming.

Finally it is clear that modifications and variations can be made to the described device without leaving the scope of protection of the present invention.

1. A cylinder lock device programmable an infinite number of times through a mechanical sequence, and a key for the said lock, characterized by the fact of comprising:
at least one key featuring at least one body having a protruding part on the surface of which can be machined a sequence of indentations, and the said key comprising a mechanism having at least one moving member capable to rotate and/or translate with respect to the body of the key; and
at least one rotor body, and
at least one stator featuring at least one cavity capable to house, even if only partially, other parts of the lock device; and
at least one locking mechanism that is driven by the action of the key between a first “locked” configuration, in which the free rotation of the rotor with respect to the stator is not possible, and a second “unlocked” configuration in which the rotor driven by the rotation of the key, can freely rotate, and the said locking mechanism comprises at least one dial member that can couple with at least part of the indentations on the key body and that dial member comprises at least two sub-components that can be coupled reciprocally in a multiplicity of different positions each of which realizes a different configuration of the dial member that matches with a specific type of indentation on the key body; and
at least one programming mechanism that can be driven between a first“coupled” configuration where the sub-components of the dial members are coupled reciprocally in a way that allows the sub-component that couples to the key indentation to drive the position of the other sub-component, and a second “decoupled” configuration where the sub-components can change their relative position in order to reach a different configuration of the dial member; and
at least one “programming mode enable” security mechanism that can be driven only through the mechanism with the moving member on the key and that allows the activation of the programming mechanism only when, at the same time, the security mechanism itself is properly driven by the mechanism of the key and the locking mechanism is in the “unlocked” configuration.

2. The device according to claim 1 wherein the said locking mechanism comprises a plurality of dial members each comprising at least one inner dial disc that has at least one tooth and at least one opening shaped so that it can couple with the protruding part of the key body where the sequenced indentations are machined, and each dial member also comprising at least one outer dial ring having at least one indentation on the peripheral edge and also a multiplicity of other indentations each capable to house the tooth of the inner disk at a different reciprocal position between the disk and the ring, thus allowing a number of coupled configurations in which the rotation of the inner disk, that is driven by the key when it is coupled to the key body, drives the rotation of the outer ring, and the said locking mechanism comprises at least one engagement member partially displaced inside a housing in the rotor body and that, in the “locked” status it is forced to remain partially displaced also in a housing in the body of the stator so that the rotation of the rotor with respect to the stator is prevented, and the said engagement member in the “unlocked” status can leave the housing in the body of the stator and displace itself inside the outer shape of the rotor in a way that enables the rotation of the rotor with respect to the stator, and the said “unlocked” status is reachable when all the dial members are driven by a partial rotation of the key in a configuration where the indentations are aligned with the housing thus leaving free the space to accept the engagement member inside the outer shape of the rotor assembly.

3. The device according to claim 2 wherein the said programming mechanism comprises a multiplicity of spacer assemblies each of them adjacent to one of the dial members and each comprising at least one outer spacer ring and one or more inner spacer disks with a shape and with an arrangement that allows the fact that an axial displacement of the pile of the inner dial disks and inner spacer disks can displace each inner dial disk inside one of the spacer rings decoupling in this way the inner dial disk from its respective outer dial ring.

4. The device according to claim 3 wherein the said axial displacement of the pile of the inner dial disks and inner spacer disks can be operated by the axial pushing action of the key thought the protruding part of a pin that acts on a front disk that shaped in a way so that the pile of inner disks is displaced axially by working against the axial reaction of a spring that acts on the opposite side of the pile through a shutter disk, and such spring reaction being strong enough to drive the inverse axial displacement when the axial action of the key is removed, and the device is furthermore characterized by the fact that the “decoupled” configuration that is reached through the said axial translation can be kept even when the axial action of the key is removed after the rotor had been rotated backward by a partial inverse rotation of the key, this due to the engagement of at least one tooth of the front disk with a properly shaped track in the rotor body that the tooth can reach in the position that allows the axial translation, so that, at the end of the partial inverse rotation of the key, the key can be extracted from the lock leaving the latter in the “decoupled” configuration and ready to accept a new key that is characterized by a different sequence of indentations.

5. The device according to claim 4 wherein each spacer assembly comprises a multiplicity of inner spacer disks with a main inner spacer disk arranged within two auxiliary inner spacer disks that do have a shape that prevents the possibility of contact points with the adjacent disks on their more external border, this in order to avoid any possible interference between the teeth of the inner dial disks, the outer spacer rings and the indentations of the outer dial rings in the “decoupled” configuration.

6. The device according to claim 1 wherein the “programming mode enable” security mechanism comprises at least one programming mode enable disk having a shape that does not allow any coupling with the protruding part of the key body and also having at least one tooth on the external border and at least one indentation capable to engage with the moving member of the key mechanism when the moving member itself is forced to partially abandon the position with respect to the key body that it had during the insertion of the key in the lock device, due to the presence of an element that, during the insertion of the key, partially occupies the housing of the moving member in the key body, and the said programming mode enable disk, once engaged by the moving member, is driven by the key in the same partial rotation that aligns the dial members in the “unlocked” configuration of the locking mechanism in order to reach a particular configuration where its teeth, each remaining inside a shaped hole on the wall of the rotor body, are aligned with a portion of this shaped hole that would not prevent an axial translation on the disk.

7. The device according to claim 6 wherein the particular configuration reached by the programming mode enable disk in which its teeth are aligned with a portion of the shaped hole that would not prevent an axial translation on the disk is a necessary but not sufficient condition in order to allow the said axial translation, due to the fact that the same teeth protrude outside the outer shape of the rotor body and engage a front circumferential raceway on the surface of the cavity of the stator ( )an this front raceway can be abandoned, in order to move into a different portion of circumferential raceway that is located at a different axial position, only when each teeth is aligned with a longitudinal groove that connects the front and the back raceway, being the said grooves located at a position that can be reached by the teeth only when the locking mechanism is in the unlocked configuration and the rotor is rotated at a suitable angle with respect to the stator.

8. The device according to claim 7 wherein at least one of the grooves that that connect the front and the back raceways coincides with an extension of the housing intended for the engagement member in the stator.

9. The device according claim 7 wherein the back circumferential raceway extends only for a fraction of the circumference so that, after having unlocked the locking mechanism, having enabled the programming mode security mechanism and having activated the programming mechanism in order to reach a “decoupled” configuration by means of an axial translation of the key, a backward rotation of the key leaves the lock device in a stable “programming” configuration where the components of the dial members are kept decoupled, the key can be extracted and substituted with another key having a different combination of the indentations on its body and that can drive the lock device back out from the “programming” configuration after having obtained a suitable change of the configuration of each dial member that matches the sequence of the indentations of the body of the new key.

10. The device according claim 1 wherein the front disk has at least one cavity that houses at least one element made of hard material with the scope of increasing the resistance of the lock against the possibility of attack by drilling.
